(19) United States
(12) Patent Application Publication
(10) Pub. No.: US 2014/0255626 A1
(43) Pub. Date: Sep. 11, 2014

(54) Sheath for Tip of Tool

(71) Applicant: Hsiu-Hua CHANG, Taichung City (TW)

(72) Inventor: Hsiu-Hua CHANG, Taichung City (TW)

(21) Appl. No.: 13/792,160

(22) Filed: Mar. 10, 2013

(51) Int. Cl. B26B 29/00

(52) U.S. Cl. CPC B26B 29/00
USPC 428/34.1

(57) ABSTRACT

A tool is provided with a sheath. The sheath includes at least one hollow body. The hollow body includes a space with an open end and a closed end opposite to the open end so that a tip of a tool can be inserted in the space through the open end.

### BACKGROUND OF INVENTION

1. Field of Invention

The present invention relates to a tool and, more particularly, to a sheath for at least one tip of a tool.

2. Related Prior Art

There are tools each of which includes at least one tip. For example, a claw hammer includes two claws each including a tip. A chisel includes a tip. An ice pick includes a tip. A mattock (or “pickaxe”) includes two tips. A crowbar includes two claws each including a tip. Such tips are sharp and might cut users or objects such as vehicles and furniture. Such tips are brittle and might get damaged when they are brought into contact with hard objects such as rocks.

Therefore, the present invention is intended to obviate or at least alleviate the problems encountered in prior art.

### SUMMARY OF INVENTION

It is the primary objective of the present invention to provide a tool with a sheath.

To achieve the foregoing objective, the sheath includes at least one hollow body. The hollow body includes a space with an open end and a closed end opposite to the open end so that a tip of a tool can be inserted in the space through the open end.

In another aspect, the sheath includes two hollow bodies. Each of the hollow bodies includes a space with an open end and a closed end opposite to the open end so that a tip of a tool can be inserted in the space through the open end.

Other objectives, advantages and features of the present invention will be apparent from the following description referring to the attached drawings.

### BRIEF DESCRIPTION OF DRAWINGS

The present invention will be described via detailed illustration of three embodiments referring to the drawings wherein:

FIG. 1 is a perspective view of a sheath according to the first embodiment of the present invention;

FIG. 2 is a perspective view of a multi-purposed hammer equipped with the sheath shown in FIG. 1;

FIG. 3 is a cut-away view of the sheath shown in FIG. 2;

FIG. 4 is a perspective view of a sheath according to the second embodiment of the present invention;

FIG. 5 is a perspective view of a sheath according to the third embodiment of the present invention;

FIG. 6 is a perspective view of a claw hammer equipped with the sheath shown in FIG. 5;

FIG. 7 is a cross-sectional view of the sheath shown in FIG. 6; and

FIG. 8 is a cross-sectional view of the sheath taken along a line 8-8 shown in FIG. 6.

### DETAILED DESCRIPTION OF EMBODIMENTS

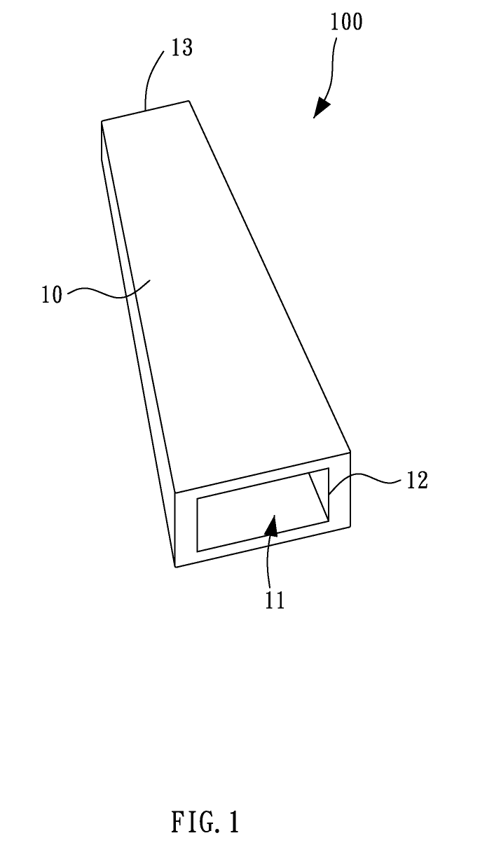

Referring to FIG. 1, there is shown a sheath 100 according to a first embodiment of the present invention. The sheath 100 includes a single hollow body 10. The hollow body 10 is made of a flexible material for absorbing shocks. The hollow body 10 is preferably in the form of a rectangular cone, i.e., it includes two lateral flat members extending to a flat upper member from a flat lower member. The hollow body 10 includes a space 11 defined therein. The space 11 includes an open end 12 and a closed end 13. The space 11 is tapered toward the closed end 13, and so is the hollow body 10. The hollow body 10 may alternatively be in the form of a circular or oval cone.

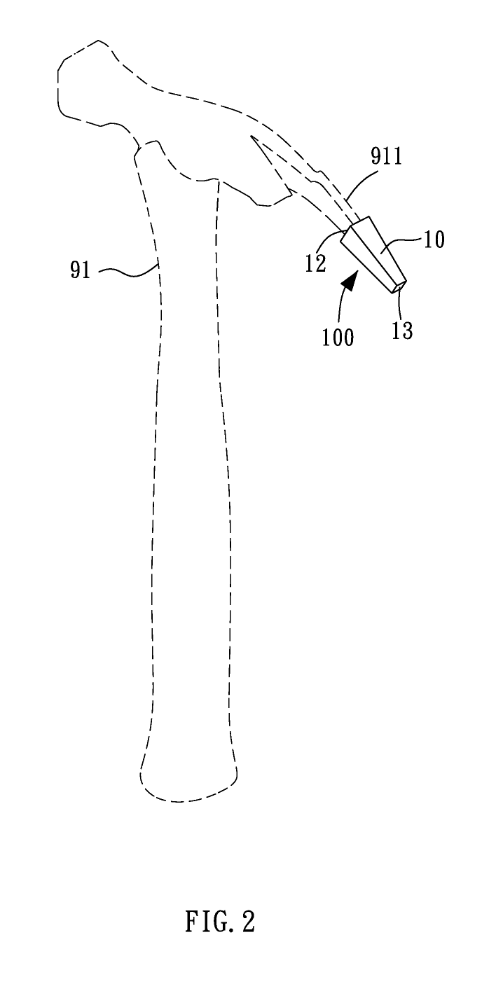

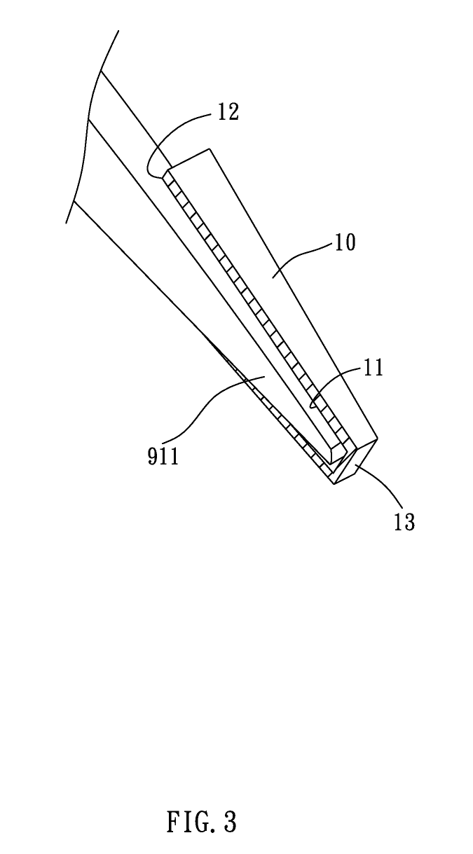

Referring to FIGS. 2 and 3, there is shown a multi-purposed hammer 91 that includes two claws and a horn 911 extending from one of the claws. The horn 911 includes a tip. The tip of the horn 911 is inserted in the space 11 through the open end 12 of the space 11. The tip of the horn 911 is wrapped by the closed end 13 of the space 11. The tip of the horn 911 is tightly placed in the space 11 since the space 11 is tapered toward the closed end 13.

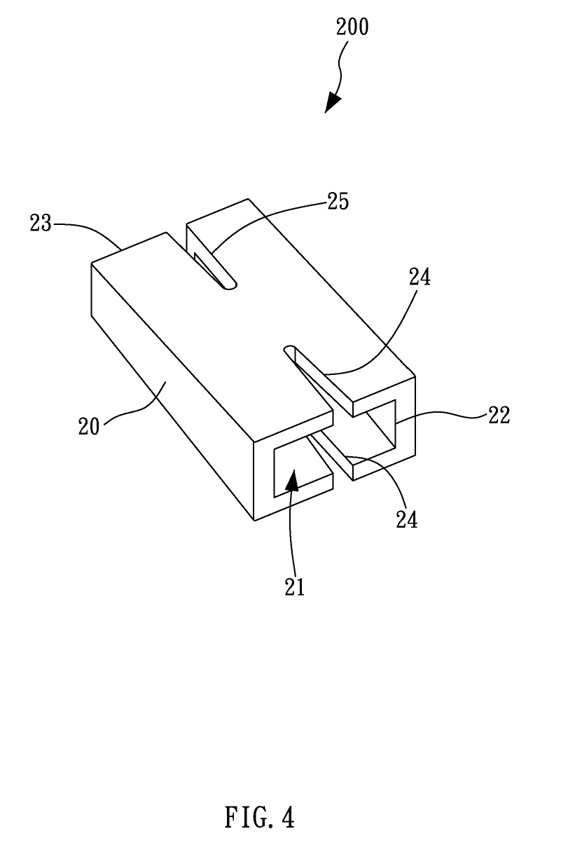

Referring to FIG. 4, there is shown a sheath 200 according to a second embodiment of the present invention. The sheath 200 includes a single hollow body 20. The hollow body 20 is in the form of a rectangular cone, i.e., it includes two lateral flat members extending to a flat upper member from a flat lower member. The hollow body 20 includes a space 21, two slits 24 and two slits 25. The space 21 includes an open end 22 and a closed end 23. The space 21 is tapered toward the closed end 23, and so is the hollow body 20. The hollow body 20 further includes two slits 24 and two slits 25. The slits 24 are respectively defined in the upper and lower flat portions thereof near the open end 22. The slits 25 are defined in the upper and lower flat portions thereof near the closed end 23. The slits 24 and 25 increase the flexibility of the hollow body 20.

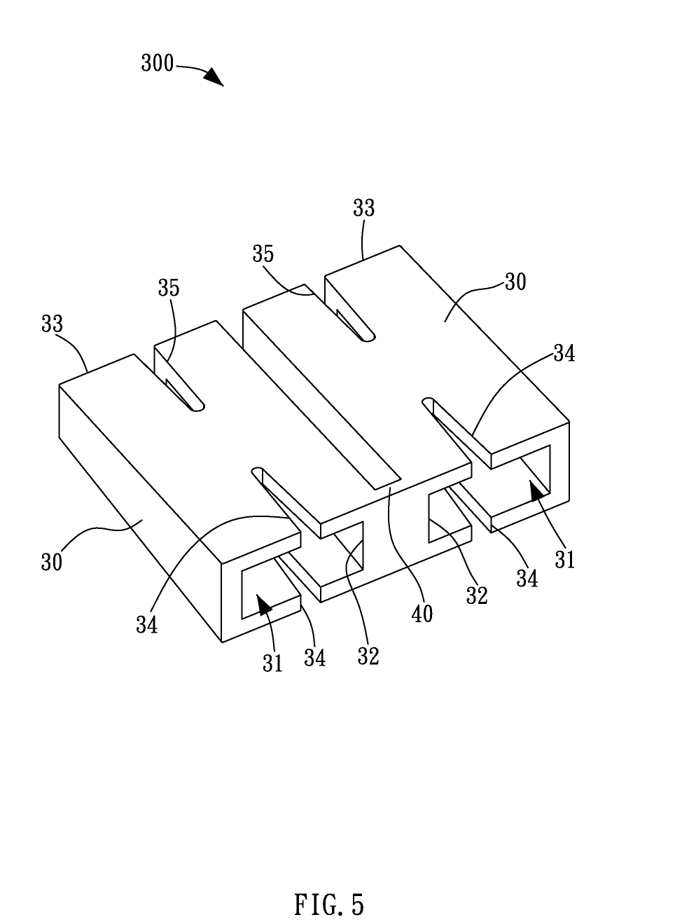

Referring to FIG. 5, there is shown a sheath 300 according to a third embodiment of the present invention. The sheath 300 includes two hollow bodies 30 joined together by a connective portion 40. The hollow bodies 30 are in the form of a rectangular cone. That is, each hollow body 30 includes two lateral flat members extending to a flat upper member from a flat lower member. Each hollow body 30 includes a space 31, two slits 34 and two slits 35. The space 31 includes an open end 32 and a closed end 33. The space 31 is tapered toward the closed end 33, and so is each hollow body 30. The slits 34 are respectively defined in the upper and lower flat portions thereof near the open end 32. The slits 35 are defined in the upper and lower flat portions thereof near the closed end 33. The slits 34 and 35 increase the flexibility of each hollow body 30.

The connective portion 40 preferably connects the open end 32 of each hollow body 30 to the open end 32 of the other hollow body 30. The connective portion 40 may alternatively connect the closed end 33 of a hollow body 30 to the closed end 33 of the other hollow body 30.

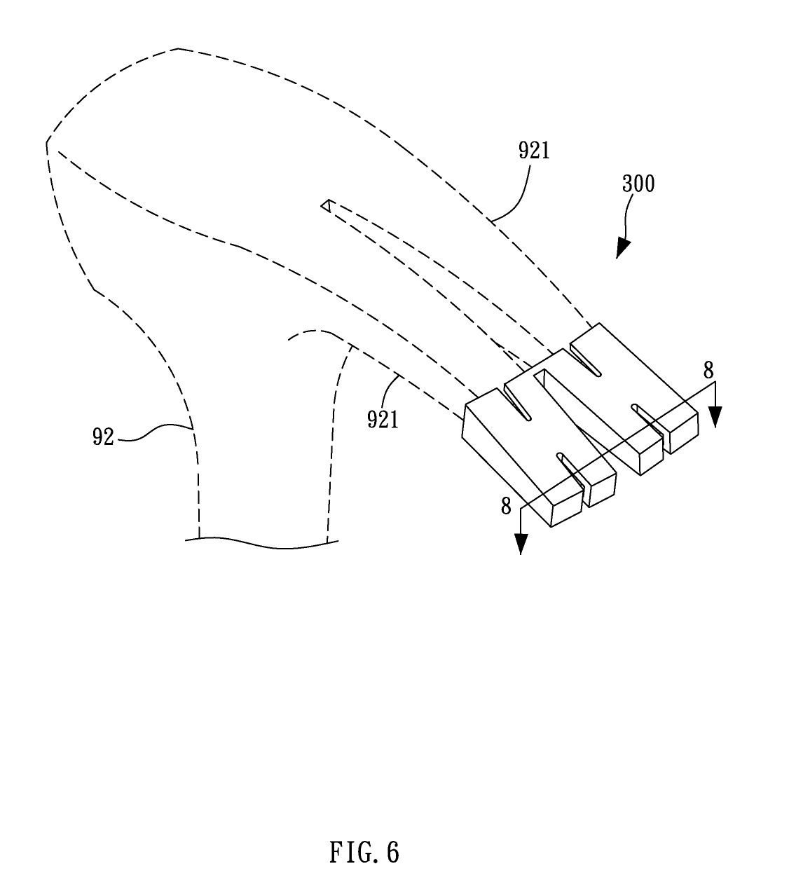

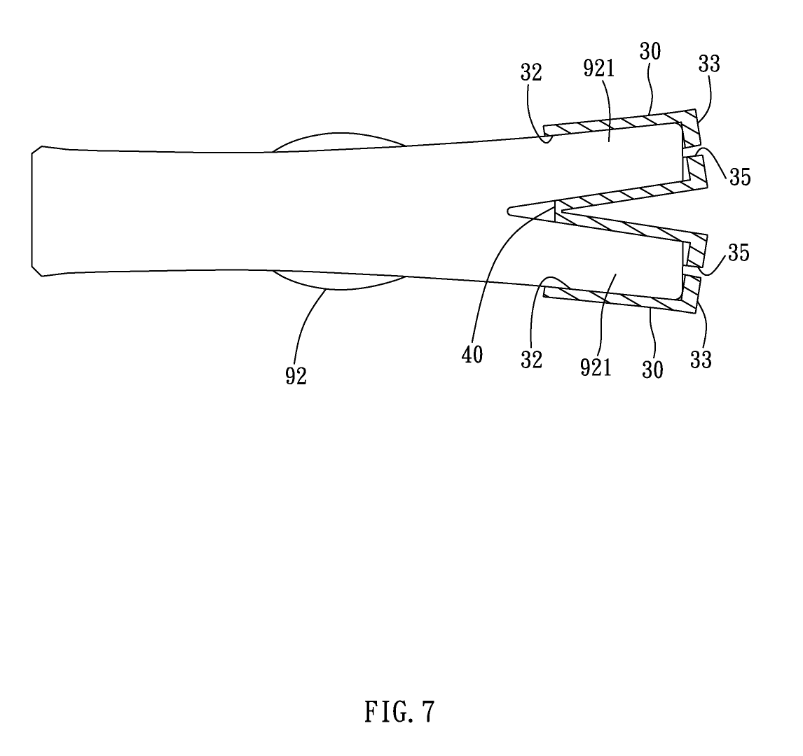

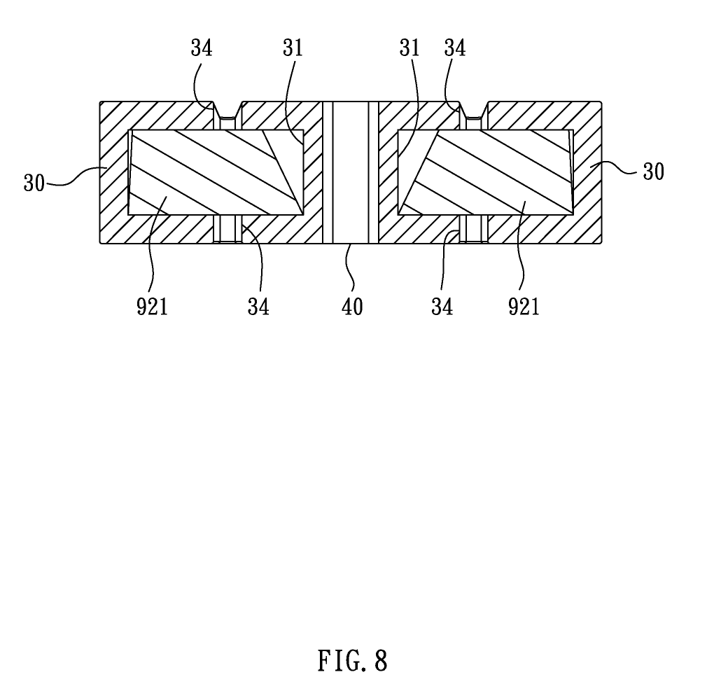

Referring to FIGS. 6 through 8, there is shown a claw hammer 92 that includes two claws 921. Each claw 921 includes a tip. The tip of each claw 921 is inserted in the space 31 of a respective hollow body 30 through the open end 32 of the space 31. The tip of each claw 921 is wrapped by the closed end 33 of the space 31 of the respective hollow body 30. The tip of each claw 921 is tightly placed in the space 31 of the respective hollow body 30 since the space 31 is tapered toward the closed end 33. The slits 34 and 35 increase the flexibility of each hollow body 30 so that the tip of each claw 921 can easily be inserted in the space 31 of the respective hollow body 30 even if the width of each claw 921 is a little larger than that of the space 31 of the respective hollow body 30 as shown in FIG. 7.

The present invention has been described via the detailed illustration of the embodiments. Those skilled in the art can derive variations from the embodiments without departing from the scope of the present invention. Therefore, the embodiments shall not limit the scope of the present invention defined in the claims.

1. A tool-used sheath including a hollow body that includes a space with an open end and a closed end opposite to the open end so that a tip of a tool can be inserted in the space through the open end.

2. The tool-used sheath according to claim 1, wherein the hollow body is made of a flexible material for absorbing shocks.

3. The tool-used sheath according to claim 1, wherein the hollow body includes a flat upper member, a flat lower member and two flat lateral members formed between the flat upper and lower members.

4. The tool-used sheath according to claim 3, wherein the space is tapered toward the closed end.

5. The tool-used sheath according to claim 1, wherein the hollow body is in the form of a cone.

6. The tool-used sheath according to claim 5, wherein the hollow body is in the form of a rectangular cone.

7. The tool-used sheath according to claim 1, wherein the hollow body includes a slit defined in each of the flat upper and lower members near the open end.

8. The tool-used sheath according to claim 7, wherein the hollow body includes a slit defined in each of the flat upper and lower members near the closed end.

9. A tool-used sheath including two hollow bodies each of which includes a space with an open end and a closed end opposite to the open end so that a tip of a tool can be inserted in the space through the open end.

10. The tool-used sheath according to claim 9, further including a connective portion for interconnecting the hollow bodies.

11. The tool-used sheath according to claim 10, wherein the connective portion and the hollow bodies are made in one piece.

12. The tool-used sheath according to claim 10, wherein the connective portion connects the open end of one of the hollow bodies to the open end of the other hollow body.

13. The tool-used sheath according to claim 9, wherein the hollow bodies are made of a flexible material for absorbing shocks.

14. The tool-used sheath according to claim 9, wherein each of the hollow bodies includes a flat upper member, a flat lower member and two flat lateral members formed between the flat upper and lower members.

15. The tool-used sheath according to claim 14, wherein the space is tapered toward the closed end.

16. The tool-used sheath according to claim 9, wherein the hollow bodies are in the form of a cone.

17. The tool-used sheath according to claim 16, wherein the hollow bodies are in the form of a rectangular cone.

18. The tool-used sheath according to claim 9, wherein each of the hollow bodies includes a slit defined in each of the flat upper and lower members near the open end.

19. The tool-used sheath according to claim 18, wherein each of the hollow bodies includes a slit defined in each of the flat upper and lower members near the closed end.
